(19) United States
(12) Patent Application Publication
(10) Pub. No.: US 2020/0400989 A1
(43) Pub. Date: Dec. 24, 2020

(54) DISPLAY PANEL, DISPLAY MODULE AND ELECTRONIC DEVICE

(71) Applicant: WUHAN CHINA STAR OPTOELECTRONICS TECHNOLOGY CO., LTD., Wuhan (CN)

(72) Inventor: Ling GAO, Wuhan (CN)

(73) Assignee: WUHAN CHINA STAR OPTOELECTRONICS TECHNOLOGY CO., LTD., Wuhan (CN)

(21) Appl. No.: 16/331,141

(22) PCT Filed: Nov. 15, 2018
(86) PCT No.: PCT/CN2018/115527

§ 371 Date: Mar. 7, 2019

(30) Foreign Application Priority Data
Sep. 29, 2018 (CN) 201811149095.8

(51) Int. Cl. G02F 1/1339; G06F 3/041; G02F 1/1335; G06F 1/16

(52) U.S. Cl. CPC G02F 1/13394; G06F 3/0412; G02F 2001/13396; G06F 1/1609; G02F 1/133514

(57) ABSTRACT

A display panel, a display module and an electronic device are provided. The display panel includes an array substrate and a color filter. The array substrate includes a first substrate and a first common electrode layer disposed on the first substrate. The color filter substrate is disposed against the array substrate. The color filter substrate includes a second substrate and a spacer on the second substrate. The spacer includes a first spacer and a second spacer. A height of the first spacer is higher than or equal to a height of the second spacer.

### BACKGROUND OF THE INVENTION

### Field of Invention

The present invention relates to a display technology, and more particularly to a display panel, a display module and an electronic device.

### Description of Prior Art

In the existing technology, the display panel includes an array substrate, a color filter substrate, and a spacer therebetween. As an important part, the spacer has always been a special consideration in design. The main function of the spacer is to support the upper and lower substrates to maintain a fixed distance between the array substrate and the color filter substrate. The material properties of the spacer itself determine that it has a certain compression ratio, so that the panel can be properly adjusted for small range spacing during handling or pressing.

The array substrate includes a common electrode plate distributed in an array. In the row direction, there are recesses resulted from certain distance between adjacent common electrode plates. Therefore, a part of the spacers will be disposed in the recesses, resulting in a certain gap between the spacers and the color filter substrate, so that partial regions of the display panel are unevenly displayed, which affects the quality of the display panel.

### SUMMARY OF THE INVENTION

In view of the above, the present invention provides a display panel, a display module and an electronic device and the problem of unevenly displaying of display panel can be solved.

In order to achieve above-mentioned object of the present invention, one embodiment of the present invention provides a display panel including an array substrate and a color filter substrate. The array substrate includes a first substrate and a first common electrode layer disposed on the first substrate. The color filter substrate is disposed against the array substrate. The color filter substrate includes a second substrate and a spacer on the second substrate. The spacer includes a first spacer and a second spacer. A height of the first spacer is higher than or equal to a height of the second spacer.

In one embodiment of the present invention, the first common electrode layer comprises at least two common electrode plates. There is a recess defined by the two adjacent common electrode plates. The height of the first spacer is higher than the height of the second spacer. The first spacer is disposed on the recess.

In one embodiment of the present invention, the first spacer includes a first part disposed near the second substrate and a second part disposed away from the second substrate.

The first part includes a first plane away from the second substrate, and an orthogonal projection of the second part on the first plane is located within the first plane.

In one embodiment of the present invention, the second part is disposed in the recess. A width of the second part is less than or equal to a distance of the recess between the two adjacent common electrode plates.

In one embodiment of the present invention, a cross section of the second part is one of square, rectangle, or trapezoid.

In one embodiment of the present invention, the second spacer is disposed on the common electrode plate, and parts of the electrode plates are corresponding to at least one second spacer.

In one embodiment of the present invention, a shape of the first part of the first spacer is the same with a shape of the second spacer.

In one embodiment of the present invention, the display panel further includes a protection layer disposed on the first common electrode plate. A surface of the protection layer away from the first substrate is a flat surface.

The height of the first spacer is equal to the height of the second spacer.

Furthermore, another embodiment of the present invention provides display module including a display panel, a touch layer, a polaroid layer and a cover layer. The touch layer, the polaroid layer and the cover layer are disposed on the display panel.

The display panel includes an array substrate, and a color filter substrate. The array substrate includes a first substrate and a first common electrode layer disposed on the first substrate.

The color filter substrate is disposed against the array substrate. The color filter substrate includes a second substrate and a spacer on the second substrate.

The spacer includes a first spacer and a second spacer. A height of the first spacer is higher than or equal to a height of the second spacer.

In one embodiment of the present invention, the first common electrode layer includes at least two common electrode plates. There is a recess defined by the two adjacent common electrode plates.

The height of the first spacer is higher than the height of the second spacer. The first spacer is disposed on the recess.

In one embodiment of the present invention, the first spacer includes a first part disposed near the second substrate and a second part disposed away from the second substrate.

The first part includes a first plane away from the second substrate, and an orthogonal projection of the second part on the first plane is located within the first plane.

In one embodiment of the present invention, the second part is disposed in the recess, and a width of the second part is less than or equal to a distance between the two adjacent common electrode plates.

In one embodiment of the present invention, the second spacer is disposed on the common electrode plate. Parts of the electrode plates are corresponding to at least one second spacer.

A shape of the first part of the first spacer is the same with a shape of the second spacer.

In one embodiment of the present invention, the display panel further includes a protection layer disposed on the first common electrode plate. A surface of the protection layer away from the first substrate is a flat surface.

The height of the first spacer is equal to the height of the second spacer.

Moreover, the other embodiment of the present invention provides an electronic device including a display module and a backlight module. The display module includes a display panel, a touch layer, a polaroid layer, and a cover layer. The touch layer, the polaroid layer and the cover layer are disposed on the display panel.

The display panel includes an array substrate and a color filter substrate. The array substrate includes a first substrate and a first common electrode layer disposed on the first substrate.

The color filter substrate is disposed against the array substrate. The color filter substrate includes a second substrate and a spacer on the second substrate.

The spacer includes a first spacer and a second spacer. A height of the first spacer is higher than or equal to a height of the second spacer.

In one embodiment of the present invention, the first common electrode layer includes at least two common electrode plates. There is a recess defined by the two adjacent common electrode plates.

The height of the first spacer is higher than the height of the second spacer. The first spacer is disposed on the recess.

In one embodiment of the present invention, the first spacer includes a first part disposed near the second substrate and a second part disposed away from the second substrate.

The first part includes a first plane away from the second substrate. An orthogonal projection of the second part on the first plane is located within the first plane.

In one embodiment of the present invention, the second part is disposed in the recess, and a width of the second part is less than or equal to a distance between the two adjacent common electrode plates.

In one embodiment of the present invention, the second spacer is disposed on the common electrode plate. Parts of the electrode plates are corresponding to at least one second spacer.

A shape of the first part of the first spacer is the same with a shape of the second spacer.

In one embodiment of the present invention, the display panel further includes a protection layer disposed on the first common electrode plate. A surface of the protection layer away from the first substrate is a flat surface. The height of the first spacer is equal to the height of the second spacer.

In comparison with the prior art, the display panel accordingly to the embodiment of the present invention eliminates the gap between some of the spacers and the color filter substrate by providing spacers with different heights. The display effect of the display panel is improved, and the quality of the display panel is improved.

### BRIEF DESCRIPTION OF THE DRAWINGS

FIG. 1 is a schematic layer view of a display panel according to the first embodiment of the present invention.

FIG. 2 is a schematic top views of a first common electrode layer of a display panel according to one embodiment of the present invention.

FIG. 3 is a schematic layer view of a display panel according to the second embodiment of the present invention.

### DETAILED DESCRIPTION OF THE PREFERRED EMBODIMENTS

The following description of the embodiments is provided by reference to the following drawings and illustrates the specific embodiments of the present invention. Directional terms mentioned in the present invention, such as “up,” “down,” “top,” “bottom,” “forward,” “backward,” “left,” “right,” “inside,” “outside,” “side,” “peripheral,” “central,” “horizontal,” “peripheral,” “vertical,” “longitudinal,” “axial,” “radial,” “uppermost” or “lowermost,” etc., are merely indicated the direction of the drawings. Therefore, the directional terms are used for illustrating and understanding of the application rather than limiting thereof.

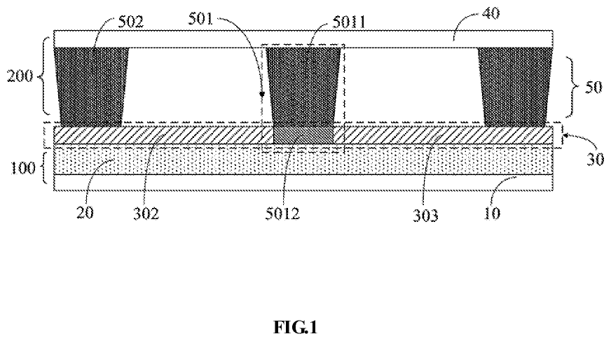

Referring to FIG. 1, FIG. 1 is a schematic layer view of a display panel according to the embodiment of the present invention.

One embodiment of the present invention provides a display panel including an array substrate 100, a color filter substrate 200 and a liquid crystal layer (not shown) disposed between the array substrate 100 and the color filter substrate 200.

The array substrate 100 includes a first substrate 10, a thin film transistor layer 20 disposed on the first substrate 10, and a first common electrode layer 30 disposed on the thin film transistor layer 20.

In an embodiment, the first substrate 10 may be one of a glass substrate, a quartz substrate, a resin substrate, and the like.

The thin film transistor layer 20 may be an etch barrier type, a back channel etch type or a top gate thin film transistor type structure, and is not particularly limited. For example, a top gate thin film transistor type thin film transistor layer 20 includes a buffer layer, an active layer, a gate insulating layer, a gate layer, an interlayer insulating layer, a source/drain, and a flat layer.

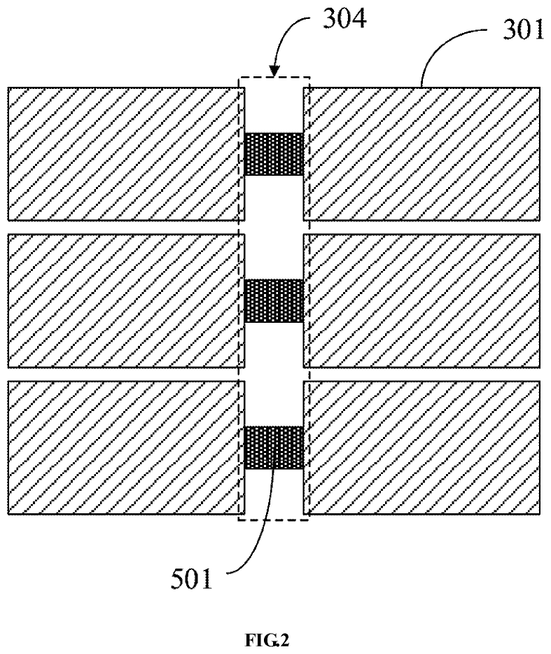

Referring to FIG. 2, FIG. 2 is a schematic top views of a first common electrode layer of a display panel according to one embodiment of the present invention.

The first common electrode layer 30 is formed on the thin film transistor layer 20, and the first common electrode layer 30 includes at least two common electrode plates 301 distributed in an array.

In the row or column direction, there is a certain distance between two adjacent common electrode plates 301. However, since the pitch between two adjacent common electrode plates 301 in the column direction is too small, a part of the spacer is disposed between the adjacent two common electrode plates 301 in the row direction. Therefore, the pitch between adjacent two common electrode plates 301 in the column direction in this embodiment is not considered.

The first common electrode layer 30 is a transparent metal layer and is made of a transparent metal material. In the row direction, there is a recess 304 defined by two adjacent common electrode plates 301.

In an embodiment, the material of the first common electrode layer 30 may be indium tin oxide.

Referring to FIG. 1, the color filter substrate 200 is disposed opposite to the array substrate 100. The color filter substrate 200 includes a second substrate 40, a color resist layer (not shown) on the second substrate 40, a black shielding layer (not shown), and the spacer 50 disposed on the color resist layer and the black shielding layer.

In an embodiment, the material of the second substrate 40 may be the same as the material of the first substrate 10. The invention is not limited this.

The color resist layer includes a plurality of red resist blocks, green resist blocks, and blue resist blocks. The color of the two adjacent color resist blocks is different. The black shielding layer is disposed between the two adjacent color resist blocks to prevent from being crosstalk.

The spacer 50 includes a first spacer 501 and a second spacer 502. A height of the first spacer 501 is higher than or equal to a height of the second spacer 502.

In one embodiment of the present invention, the height of the first spacer 501 is higher than the height of the second spacer 502.

In one embodiment of the present invention, the first spacer 501 is disposed on the recess 304. The first spacer 501 is docked with the recess 304.

In one embodiment of the present invention, the first spacer 501 includes a first part 5011 disposed near the second substrate 40 and a second part 5012 disposed away from the second substrate 40. The first part 5011 includes a first plane away from the second substrate 40, and an orthogonal projection of the second part 5012 on the first plane is located within the first plane.

Referring to FIG. 1, in one embodiment of the present invention, a shape of the first part 5011 of the first spacer 501 is the same with a shape of the second spacer 502.

In one embodiment of the present invention, the shape of the first part 5011 of the first spacer 501 and the shape of the second spacer 502 are inverted trapezoid. A first side adjacent to the second substrate 40 is larger than a second side away from the second substrate 40.

In one embodiment of the present invention, a shape of the second part 5012 of the first spacer 501 may be set according to the shape of the recess 304. The second part 5012 is disposed in the recess 304. A width of the second part 5012 is less than or equal to a distance of the recess 304 between the two adjacent common electrode plates 301.

In one embodiment of the present invention, the width of the second part 5012 is equal to a distance of the recess 304 between the two adjacent common electrode plates 301. The second part 5012 is just embedded within the recess 304.

The width of the second part 5012 may be smaller than the distance of the recess 304 between the two adjacent common electrode plates 301. The second portion 5012 does not completely fill the spacing of the recess 304 in the row direction.

The shape of the second portion 5012 is not specifically limited in this embodiment.

In one embodiment of the present invention, a cross section of the second part 5012 is one of square, rectangle, or trapezoid.

In one embodiment of the present invention, the second spacer 502 is disposed on a first common electrode plate 302, and parts of the first electrode plates 302 are corresponding to at least one second spacer 502.

Referring to FIG. 1, the first common electrode layer 30 includes first common electrode plates 302 and second common electrode plates 303. There is a recess 304 defined by the first common electrode plates 302 and the second common electrode plates 303.

The first spacer 501 is disposed between the first common electrode plate 302 and the second common electrode plate 303. There is one of the second spacers 502 disposed on the first common electrode plate 302 and one of the second spacers 502 disposed on the second common electrode plate 303.

In one embodiment of the present application, the number of the second spacers 502 on the first common electrode plate 302 is not specifically limited, and may be set according to actual conditions.

In one embodiment of the present application, the first common electrode plate 302 and the second common electrode plate 303 in FIG. 1 have the same structure as the common electrode plate 301 in FIG. 2

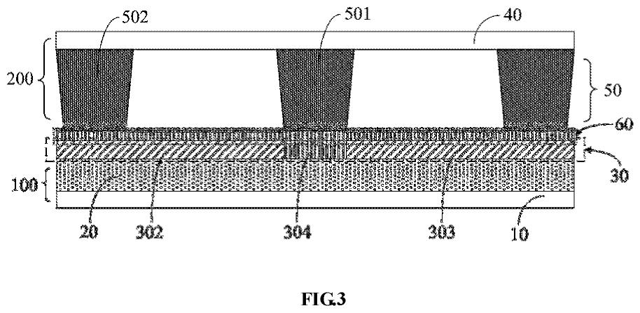

Referring to FIG. 3, FIG. 3 is a schematic layer view of a display panel according to the second embodiment of the present invention.

The display panel further includes a protection layer 60 disposed on the first common electrode plate 302. The surface of the protection layer 60 away from the first substrate 10 is a flat surface.

In one embodiment of the present application, the height of the first spacer 501 is the same as the height of the second spacer 502.

In an embodiment of the present application, the material of the protection layer 60 may be a high fluidity insulating material. When the protection layer 60 is formed, the protection layer 60 fills the recess 304 to ensure that the surface of the protection layer 60 away from the first substrate 10 is a flat surface.

In one embodiment of the present application, the heights of the first spacer 501 and the second spacer 502 can be set to have the same height without the cumbersome arrangement of the first embodiment.

Furthermore, another embodiment of the present invention provides display module including a display panel, a touch layer, a polaroid layer and a cover layer. The touch layer, the polaroid layer and the cover layer are disposed on the display panel.

According to still another aspect of the present application, an electronic device is provided. The electronic device including the display module. The electronic device may be, including but not limited to, a mobile phone, a tablet computer, a computer display, a game machine, a television, a display screen, a wearable device, and other daily appliances or household appliances having a display function.

The working principle of the display module, the electronic device, and the display panel are similar. The working principle of the display module and the electronic device can be specifically referred to the working principle of the display panel. It will not go into details here.

The present application provides a display panel, a display module, and an electronic device. The display panel includes an array substrate and a color filter substrate. The array substrate includes a first substrate and a first common electrode layer disposed on the first substrate. The color filter substrate is disposed against the array substrate. The color filter substrate includes a second substrate and a spacer on the second substrate. The spacer includes a first spacer and a second spacer. A height of the first spacer is higher than or equal to a height of the second spacer. In the present application, by providing the spacers with different heights, the gap between some of the spacers and the color filter substrate is eliminated, the display effect of the display panel is improved, and the quality of the display panel is improved.

The present invention has been described by the above embodiments, but the embodiments are merely examples for implementing the present invention. It must be noted that the embodiments do not limit the scope of the invention. In contrast, modifications and equivalent arrangements are intended to be included within the scope of the invention.

1. A display panel, comprising:
an array substrate comprising a first substrate and a first common electrode layer disposed on the first substrate; and
a color filter substrate disposed against the array substrate, and the color filter substrate comprising a second substrate and a spacer on the second substrate, wherein the spacer comprises a first spacer and a second spacer, and a height of the first spacer is higher than or equal to a height of the second spacer.

2. The display panel according to claim 1, wherein the first common electrode layer comprises at least two common electrode plates, there is a recess defined by the two adjacent common electrode plates, the height of the first spacer is higher than the height of the second spacer, and the first spacer is disposed on the recess.

3. The display panel according to claim 2, wherein the first spacer comprises a first part disposed near the second substrate and a second part disposed away from the second substrate, the first part comprises a first plane away from the second substrate, and an orthogonal projection of the second part on the first plane is located within the first plane.

4. The display panel according to claim 3, wherein the second part is disposed in the recess, and a width of the second part is less than or equal to a distance between the two adjacent common electrode plates.

5. The display panel according to claim 3, wherein a cross section of the second part is one of square, rectangle, or trapezoid.

6. The display panel according to claim 2, wherein the second spacer is disposed on the common electrode plate, and parts of the electrode plates are corresponding to at least one second spacer.

7. The display panel according to claim 6, where a figure of the first part of the first spacer is the same with a figure of the second spacer.

8. The display panel according to claim 1, wherein the first common electrode layer includes a first common electrode plate and a second common electrode plate, the display panel further comprises a protection layer disposed on the first common electrode plate, a surface of the protection layer away from the first substrate is a flat surface, and the height of the first spacer is equal to the height of the second spacer.

9. A display module, comprising:
A display panel;
A touch layer;
A polaroid layer; and
A cover layer, wherein the touch layer, the polaroid layer and the cover layer are disposed on the display panel, and the display panel comprises:
an array substrate comprising a first substrate and a first common electrode layer disposed on the first substrate; and
a color filter substrate disposed against the array substrate, and the color filter substrate comprising a second substrate and a spacer on the second substrate, wherein the spacer comprises a first spacer and a second spacer, and a height of the first spacer is higher than or equal to a height of the second spacer.

10. The display module according to claim 9, wherein the first common electrode layer comprises at least two common electrode plates, there is a recess defined by the two adjacent common electrode plates, the height of the first spacer is higher than the height of the second spacer, and the first spacer is disposed on the recess.

11. The display module according to claim 10, wherein the first spacer comprises a first part disposed near the second substrate and a second part disposed away from the second substrate, the first part comprises a first plane away from the second substrate, and an orthogonal projection of the second part on the first plane is located within the first plane.

12. The display module according to claim 11, wherein the second part is disposed in the recess, and a width of the second part is less than or equal to a distance between the two adjacent common electrode plates.

13. The display module according to claim 10, wherein the second spacer is disposed on the common electrode plate, parts of the electrode plates are corresponding to at least one second spacer, and a figure of the first part of the first spacer is the same with a figure of the second spacer.

14. The display module according to claim 9, wherein the first common electrode layer includes a first common electrode plate and a second common electrode plate, the display panel further comprises a protection layer disposed on the first common electrode plate, wherein a surface of the protection layer away from the first substrate is a flat surface, and the height of the first spacer is equal to the height of the second spacer.

15. An electronic device, comprising a display module, wherein the display module comprises:
a display panel;
a touch layer;
a polaroid layer; and
a cover layer, wherein the touch layer, the polaroid layer and the cover layer are disposed on the display panel, and the display panel comprises:
an array substrate comprising a first substrate and a first common electrode layer disposed on the first substrate; and
a color filter substrate disposed against the array substrate, and the color filter substrate comprising a second substrate and a spacer on the second substrate, wherein the spacer comprises a first spacer and a second spacer, and a height of the first spacer is higher than or equal to a height of the second spacer.

16. The electronic device according to claim 15, wherein the first common electrode layer comprises at least two common electrode plates, there is a recess defined by the two adjacent common electrode plates, the height of the first spacer is higher than the height of the second spacer, and the first spacer is disposed on the recess.

17. The electronic device according to claim 16, wherein the first spacer comprises a first part disposed near the second substrate and a second part disposed away from the second substrate, the first part comprises a first plane away from the second substrate, and an orthogonal projection of the second part on the first plane is located within the first plane.

18. The electronic device according to claim 17, wherein the second part is disposed in the recess, and a width of the second part is less than or equal to a distance between the two adjacent common electrode plates.

19. The electronic device according to claim 16, wherein the second spacer is disposed on the common electrode plate, parts of the electrode plates are corresponding to at least one second spacer, and a figure of the first part of the first spacer is the same with a figure of the second spacer.

20. The electronic device according to claim 15, wherein the first common electrode layer includes a first common electrode plate and a second common electrode plate, the display panel further comprises a protection layer disposed on the first common electrode plate, wherein a surface of the protection layer away from the first substrate is a flat surface, and the height of the first spacer is equal to the height of the second spacer.
